(19) United States
(12) Patent Application Publication
(10) Pub. No.: US 2014/0273789 A1
(43) Pub. Date: Sep. 18, 2014

(54) HVAC CASE DESIGN FOR REDUCED VALVE NOISE

(71) Applicant: DELPHI TECHNOLOGIES, INC., TROY, MI (US)

(72) Inventors: ARDEEAN SCOCCIA, AMHERST, NY (US); THEODORE LIPA, III, LOCKPORT, NY (US)

(21) Appl. No.: 14/205,959

(22) Filed: Mar. 12, 2014

Related U.S. Application Data
(60) Provisional application No. 61/777,171, filed on Mar. 12, 2013.

(51) Int. Cl. B60H 1/34

(52) U.S. Cl. CPC B60H 1/3421
USPC 454/155

(57) ABSTRACT

A heating, ventilation, and air conditioning (HVAC) module includes a housing and a valve. The housing defines a protruding portion that substantially conforms to a portion of an arching pathway defined by a distal end of the valve. The protruding portion may be configured so a distance between the protruding portion and the distal end may vary from more to less as the distal end moves toward where the valve is in a closed position.

### CROSS-REFERENCE TO RELATED APPLICATION

This application claims the benefit under 35 U.S.C. §119(e) of U.S. Provisional Patent Application No. 61/777,171, filed Mar. 12, 2013, the entire disclosure of which is hereby incorporated herein by reference.

### TECHNICAL FIELD OF INVENTION

This disclosure generally relates to automotive Heating, Ventilation, and Air conditioning (HVAC) Modules, and more particularly relates to a housing or case design with features to reduce valve closing noise.

### BACKGROUND OF INVENTION

In an automotive Heating, Ventilation, and Air conditioning (HVAC) Module, Valves are used to control the airflow at each exit point of the Module. Commonly used Valves are of various designs and constructions: end pivot, center pivot, rubber over-mold, foam paddle, single paddle, split paddle, as well as a wide range of lengths and widths (radius). Large, split, end pivot paddles are the most difficult to control as they approach closure of an exit opening. The strong force of the airflow when the blower is at one of the higher speed settings commonly causes the Valve to slam shut, making an objectionable noise transmitted through the vehicle. Less common, but even more offensive, is when a resonance is established, based on the right combination of factors, that results in a continuous fluttering of the Valve, or banging, against the Case seat. This is completely unacceptable and has to be avoided.

To resolve these problems, solutions include felt washers placed on the Valve shaft to create enough interference to prevent flutter. These may not solve the slap problem. Placement of foam bumper pads may also be used but is not consistent or durable, and results in deformation of the Valve and air leakage when closed. The addition of a thin layer of foam may be used, but is vulnerable to variation in position, in effectiveness, and risk of separating from the Case surface in time. Each of these solutions requires the addition of parts and the associated error-proofing.

### SUMMARY OF THE INVENTION

Described herein is an improvement to the shaping of the Case wall that leads to the seat that the Valve shuts off against when blocking airflow from exiting the Module. The wall is shaped such that the gap between the Valve tip and the adjoining Case wall is carefully controlled—gradually decreasing as the Valve approaches the seat. The limiting and decreasing of the gap effectively prevents the airflow from having sufficient energy to establish a resonance as the Valve approaches the seat, and also prevents the noisy slap as the Valve seats itself and closes the opening.

In accordance with one embodiment, a heating, ventilation, and air conditioning (HVAC) module is provided. The HVAC module includes a housing and a valve. The housing has an interior wall that defines an air passageway. The valve is operative to open and close the air passageway. The valve includes a planar portion having a distal end movable in an arching pathway between an open position and in a closed position. The interior wall includes a protruding portion that substantially conforms to a portion of the arching pathway of the distal end, and a seat portion that engages the distal end when the distal end is in the closed position.

In accordance with another embodiment, a distance between the protruding portion and the distal end varies from more to less as the distal end moves toward where the valve is in the closed position.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a cut-away view of a known HVAC module in accordance with one embodiment;

FIG. 2 is another cut-away view of the known HVAC module of FIG. 1;

FIG. 3 is a cut-away side view of an improved HVAC module in accordance with one embodiment;

FIG. 4 is another cut-away side view of the improved HVAC module of FIG. 3 in accordance with one embodiment;

FIG. 5 is cut-away perspective view of the improved HVAC module of FIG. 3 in accordance with one embodiment; and

FIG. 6 is a simplified cut-away side view of the improved HVAC module of FIG. 3 in accordance with one embodiment.

### DETAILED DESCRIPTION

FIGS. 1 and 2 illustrates an example of a known heating, ventilation, and air conditioning (HVAC) module, hereafter the known HVAC module 100, which may be installed in an automobile (not shown). The known HVAC module 100 includes a known housing 102 to contain and/or direct flowing air 104 to various locations in the automobile based on the position of valves 106, 108, 110. It was observed that in some circumstances the known HVAC module 100 would generate undesirable noise when the valve 106 was close to a seat portion 112 of a wall 114 of the housing 102.

FIG. 3 illustrates a non-limiting example of an HVAC module 10 that includes features to overcome the noise problems present in the prior art. In general, the HVAC module 10 includes a housing 12 that has or defines an interior wall 14 to help contain or route air flowing through the HVAC module 10. Part of the interior wall 14 defines an air passageway 16 that may be coupled to, for example, a duct leading to an air outlet into the interior of a vehicle (not shown) such as an automobile.

The HVAC module 10 also includes a valve 18 operable to open and close the air passageway 16. The valve 18 includes a planar portion 20 having a distal end 22 movable in an arching pathway 24 (FIG. 6) between an open position 26 and in a closed position 28.

The interior wall 14 includes or defines a protruding portion 30 that substantially conforms to a portion of the arching pathway 24 of the distal end 22. The protruding portion 30 serves to reshape the interior wall 14 to reduce or vary a distance 32 between the distal end 22 and the interior wall. As used herein, the term ‘substantially conforms’ is used to contrast the shape of the interior wall 14 (e.g. curved) provided by the protruding portion 30 with the shape of the wall 114 shown in FIG. 2, which is flat. By way of example and not limitation, the distance 32 may be varied from 1.0 millimeter when the valve 18 is at the closed position 28 to 3.0 millimeter when the valve has rotated 20 degrees away from the closed position as illustrated in FIG. 4. The protruding portion 30 may be integrally molded into the housing 12, or may be a separate part that is attached to the interior wall 14 of the housing 12 by, for example, an adhesive.

The interior wall 14 may also define or include a seat portion 34 that engages the distal end 22 when the distal end 22 (i.e. the valve 18) is in the closed position 28. The seat portion 34 provides a sealing surface for the valve 18 so that the flowing air is more effectively blocked when the air passageway 16 is closed by the valve 18.

It may be advantageous for the protruding portion 30 to be contoured so the distance 32 between the protruding portion 30 and the distal end 22 varies in distance from more to less as the distal end moves toward said seat portion in the closed position. By way of example and not limitation, the distance 32 may be varied from 1.0 millimeter when the valve 18 is at the closed position 28 to 3.0 millimeter when the valve has rotated 20 degrees away from the closed position as illustrated in FIG. 4. By varying the distance 32, the amount of air flowing through the air passageway 16 may be more precisely controlled by varying the angle of the valve 18. That is, the shape of the protruding portion 30 helps to reduce the amount of change in airflow for a given change in valve angle when the valve is near the closed position 28.

FIG. 5 illustrates a non-limiting example of how the protruding portion 30 may have a three-dimensional contour that cooperates with the shape of the valve 18 to further provide for reduced noise and precise airflow control.

Accordingly, a HVAV module 10 is provided. The addition of the protruding portion 30 to the interior wall 14 of the housing 12 helps to advantageously reduce noise by reducing the amount of air flow change per unit change of valve angle when the valve 18 is near the closed position 28.

While this invention has been described in terms of the preferred embodiments thereof, it is not intended to be so limited, but rather only to the extent set forth in the claims that follow.

1. A heating, ventilation, and air conditioning (HVAC) module comprising:
a housing having an interior wall defining an air passageway; and
a valve operative to open and close said air passageway, wherein said valve includes a planar portion having a distal end movable in an arching pathway between an open position and a closed position,
wherein said interior wall includes a protruding portion that substantially conforms to a portion of said arching pathway of said distal end, and a seat portion that engages said distal end when said distal end is in said closed position.

2. The HVAC module in accordance with claim 1, wherein a distance between said protruding portion and said distal end varies from more to less as the distal end moves toward where the valve is in the closed position.
